(19) United States
(12) Patent Application Publication
(10) Pub. No.: US 2014/0175130 A1
(43) Pub. Date: Jun. 26, 2014

(54) Container with Power Wash

(71) Applicant: Justin Wheeless, Tallahassee, FL (US)

(72) Inventor: Justin Wheeless, Tallahassee, FL (US)

(21) Appl. No.: 13/726,432

(22) Filed: Dec. 24, 2012

(51) Int. Cl. B65D 88/54

(52) U.S. Cl. CPC B67D 7/62
USPC 222/333

(57) ABSTRACT

The container disclosed has a first compartment and a second compartment. The first compartment is formed by a sidewall extending upward from a base and a top and is capable of storing water. The second compartment is formed by a removable section and the side wall of the first compartment. A pump assembly and switch assembly are housed in the second compartment. A first tube extends from the pump assembly in the second compartment through a first opening in the side wall to the first compartment. Pump assembly connects to a power source by an electric wire. An optional third compartment can house an internal power source. When activated pump assembly provides suction to first tube which collects water from first compartment. Water is pressurized in a high pressure pump and expelled through a nozzle conduit and spray nozzle for use.

### CROSS-REFERENCES TO RELATED APPLICATIONS

This application is a continuation-in-part of U.S. application Ser. No. 13/194,239 which is titled Ice Cooler with Power Wash, lists the same inventor and remains pending.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of containers. More specifically, the invention comprises a container with a high pressure pump and sprayer integrated into the container.

2. Description of the Related Art

Coolers and containers for water have been in use for years. Ice coolers are typically filled with ice and used to keep items cold. As time passes, ice slowly melts to water within the cooler. Several coolers have been designed with a plug or release valve at the base of the cooler, which can be opened to allow water to escape the cooler. Other cooler devices have been developed which contain at least one compartment having a manual or non-electric pump. Such manual pumping systems are used to force water out of the cooler via a tube. However, the pressurized force is low and therefore the melted ice water is not able to be used under high pressure. Additionally, any pumping system is subject to normal wear and tear which may require servicing or replacement parts. Prior art systems are unable to provide an easily removable pumping system component for shipping, service or full replacement.

Therefore what is needed is a container which contains a high pressure pump to pump water out of the main container of a container such as an ice cooler with the desired pressure. Additionally, a pumping system that is easy to replace and or repair apart from the bulky container is desirable. The present invention achieves this objective, as well as others that are explained in the following description.

### BRIEF SUMMARY OF THE INVENTION

The present invention is a container having a first compartment and a second compartment. An optional third compartment can be included to house a power source. The first compartment has a sidewall extending upward from base and a top. The second compartment, shares the sidewall of the first compartment such that the opening for the second compartment is accessible even when the first compartment is closed by the top. A removable section or wall encloses second compartment. A full pump assembly and switch assembly are attached to the removable section. The first compartment and second compartment are connected by a first tube which extends through a small opening in the second compartment into the first compartment to access melted ice water forming on the base of the first compartment. When the user activates the switch assembly, the pump assembly is activated. Pump runs off of an energy source located outside of the container or in an optional third compartment. The optional third compartment is fluidly disconnected with the first compartment so that the power source in the third compartment is not affected by water. An electric wire connects the pump assembly to the power source.

The pump suctions water through the first tube into a high pressure pump which pressurizes the water and expels it into a nozzle conduit running to a spray nozzle.

### BRIEF DESCRIPTION OF THE SEVERAL VIEWS OF THE DRAWINGS

FIG. 1 is a perspective view, showing the present invention.

FIG. 2 is a perspective view, showing the present invention with removable section apart from main portion of container.

FIG. 3 is a perspective view, showing removable section with pump assembly and spray nozzle assembly.

FIG. 4 is a cross section view, showing the first and second compartments of the present container.

FIG. 5 is a perspective view, showing the container with removable section attached thereto.

FIG. 6 is a perspective view, showing the container attached to external power source.

FIG. 7 is a perspective view, showing the container in use with the front wall of container cut away.

FIG. 8 is a perspective view, showing a second embodiment of the present container mounted in the bed of a truck.

FIG. 9 is a cut away view, showing a second embodiment of the present container.

FIG. 10 is a schematic plan view, showing a second embodiment of the present container.

REFERENCE NUMERALS IN THE DRAWINGS

| | | | |
|---|---|---|---|
| 10 | container | 12 | top |
| 14 | side wall | 16 | second compartment |
| 18 | first opening | 20 | first compartment |
| 22 | spray nozzle | 24 | spray nozzle conduit |
| 26 | first tube | 28 | second tube |
| 30 | recessed nozzle access | 32 | switch assembly |
| 34 | pump | 36 | first electric wire |
| 38 | second electric wire | 40 | base |
| 42 | removable section | 44 | back wall |
| 46 | side walls | 48 | pump assembly |
| 50 | spray nozzle assembly | 52 | filter |
| 54 | nozzle connection | 56 | electrical connection |
| 58 | power source | 60 | ice |
| 62 | cans | 64 | water |
| 66 | third compartment | 68 | brackets |
| 70 | lid | 72 | truck bed |
| 74 | wheel well | 76 | decorative panels |
| 78 | removable section | 80 | holder |
| 82 | second opening | 84 | lower opening |
| 86 | adapter hose | 88 | wire harness |
| 90 | auxiliary water tank | | |

### DETAILED DESCRIPTION OF THE INVENTION

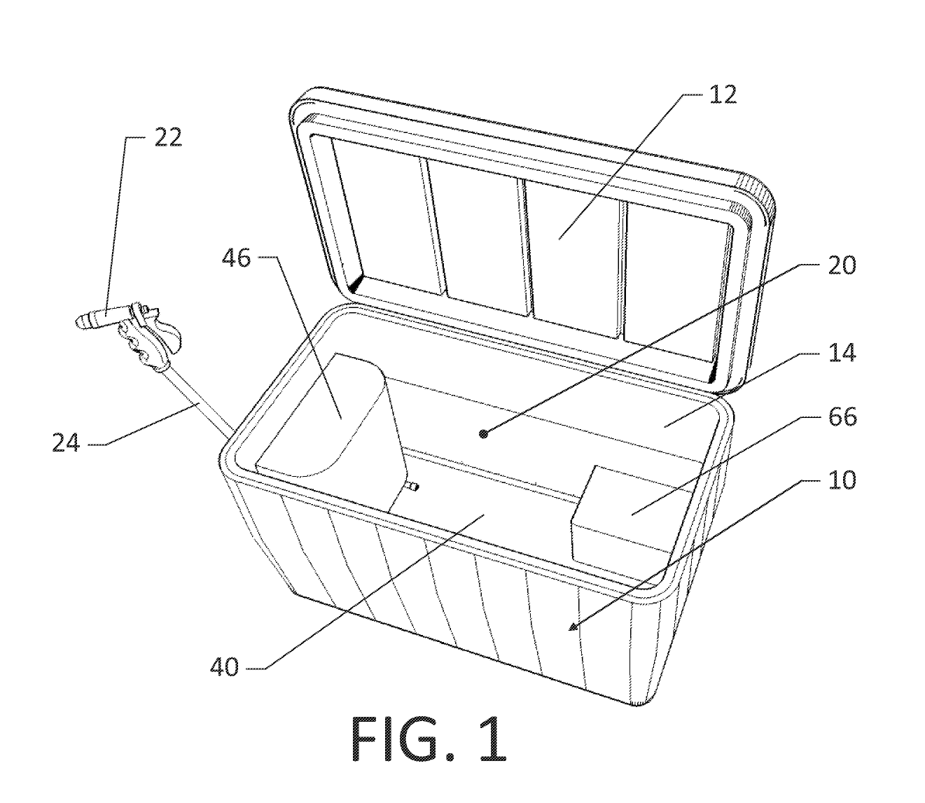

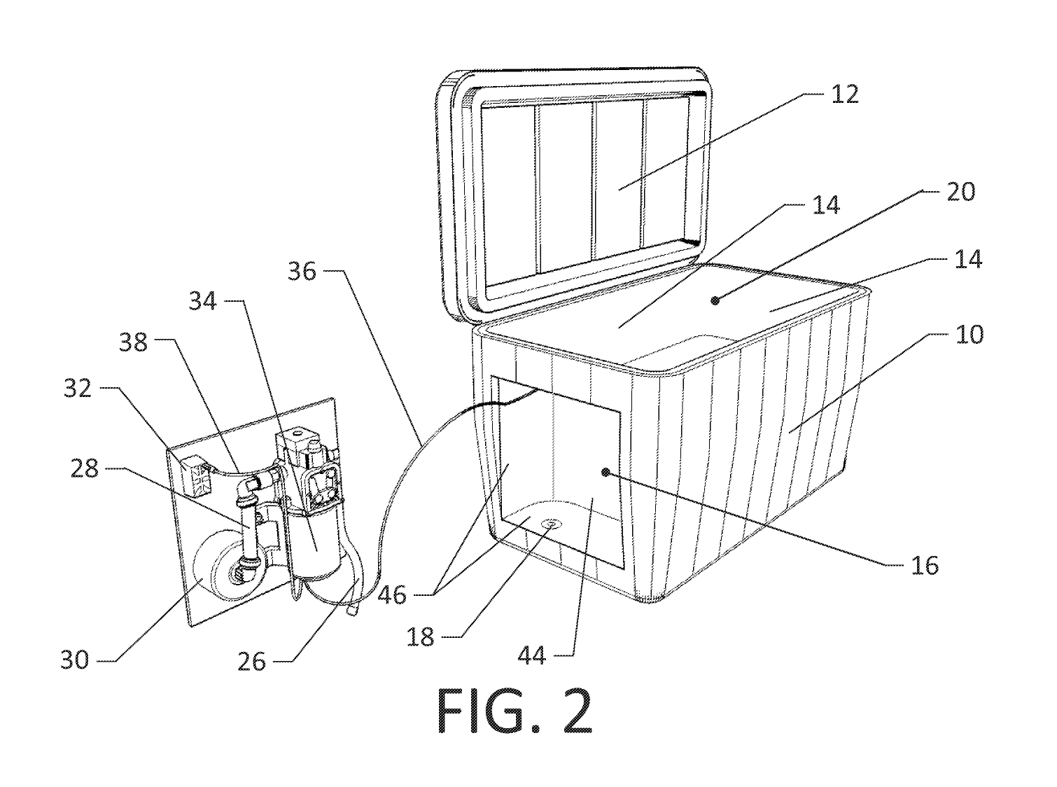

FIG. 1 illustrates the present container in the preferred embodiment. Container 10 can be a cooler having insulation to maintain cooler temperatures within container. As shown, container 10 is made up of a first compartment 20, having a base 40 and a sidewall 14. Top 12 encloses first compartment 20 at the top of sidewall 14. First compartment 20 and top 12 can be fully insulated and able to form an enclosed compartment for placement of items that the user desires to keep at cold temperatures. Side walls 46 of second compartment 16 (shown in FIG. 2) are illustrated extending into first compartment 20. In the preferred embodiment there is a slight gap between side walls 46 and base 40. However, side walls 46 could extend to base 40. Spray nozzle 22 is shown attached to spray nozzle tube 24 extending out from container 10. An optional third compartment 66 is illustrated at base 40 of container 10. Third compartment 66 serves as a housing unit for a power source (such as an internal rechargeable battery).

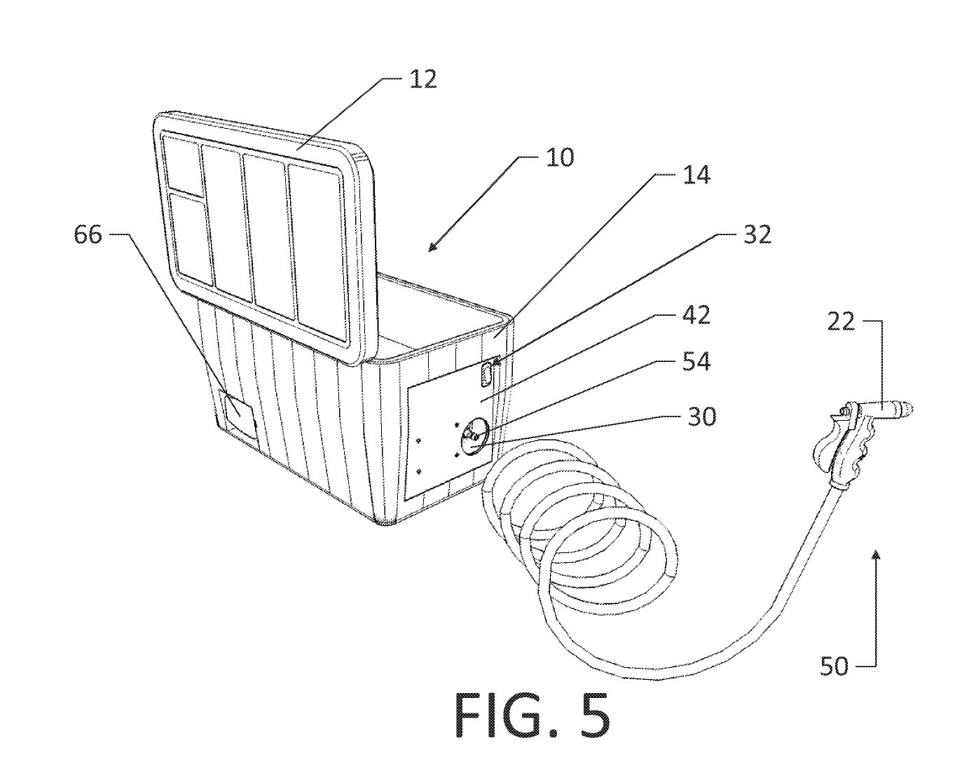

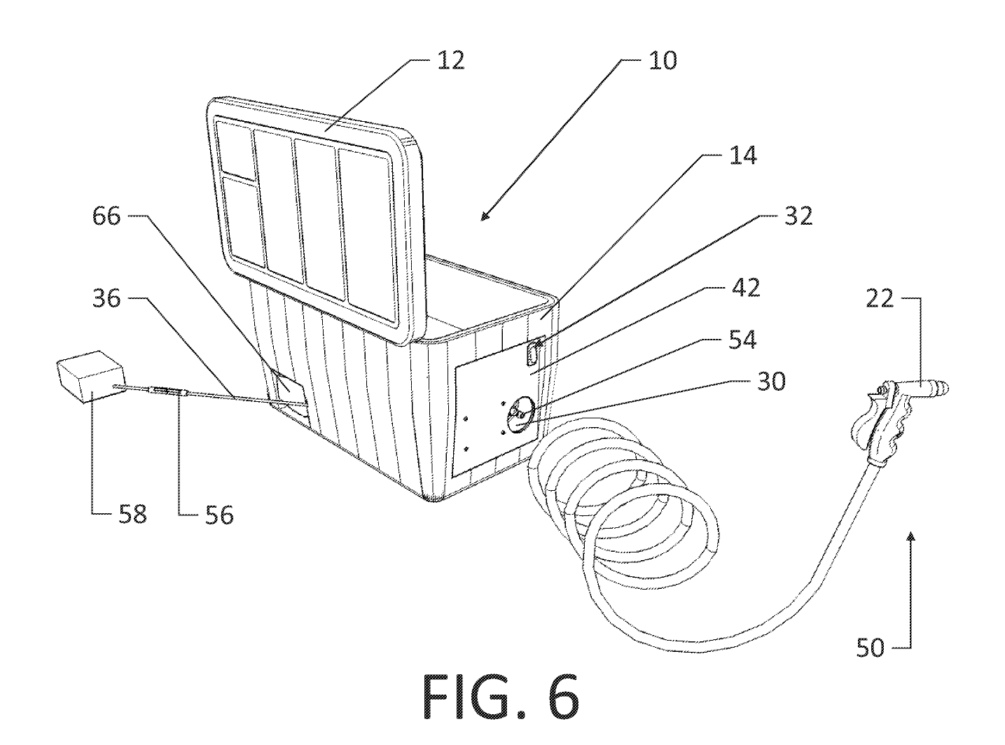

Additional details of container 10 are shown in FIG. 2. Due to the position of second compartment 16 and the location of removable section 42, a user is able to access second compartment 16 even when top 12 is closed over first compartment 20. First opening 18 is located within side wall 46 of second compartment 16. When removable section 42 is in position covering second compartment 16, first tube 26 extends from pump 34 down through first opening 18 into first compartment 20 to access water at base of container 10. Pump 34 is run by a power source (an example of which is shown in FIG. 5-6). First electric wire 36 can run to an internal power source (such as a battery) or an external power source in order to provide power to pump 34. First electric wire 36 can run through side wall 14 of first compartment 20. First electric wire 36 can exit the back of container 10; or first electric wire 36 can run to the opposing end of container, to a third compartment 66 (shown in FIGS. 1 and 5) where an internal power source is provided. In the first embodiment first electric wire 36 preferably connects with either an AC wall outlet or 12 v battery source. In the preferable embodiment a strong battery would be housed within container 10. Battery would be a rechargeable Ni-Cad battery which would either be completely removable or contain an attachment for plugging directly into an AC outlet for recharging purposes.

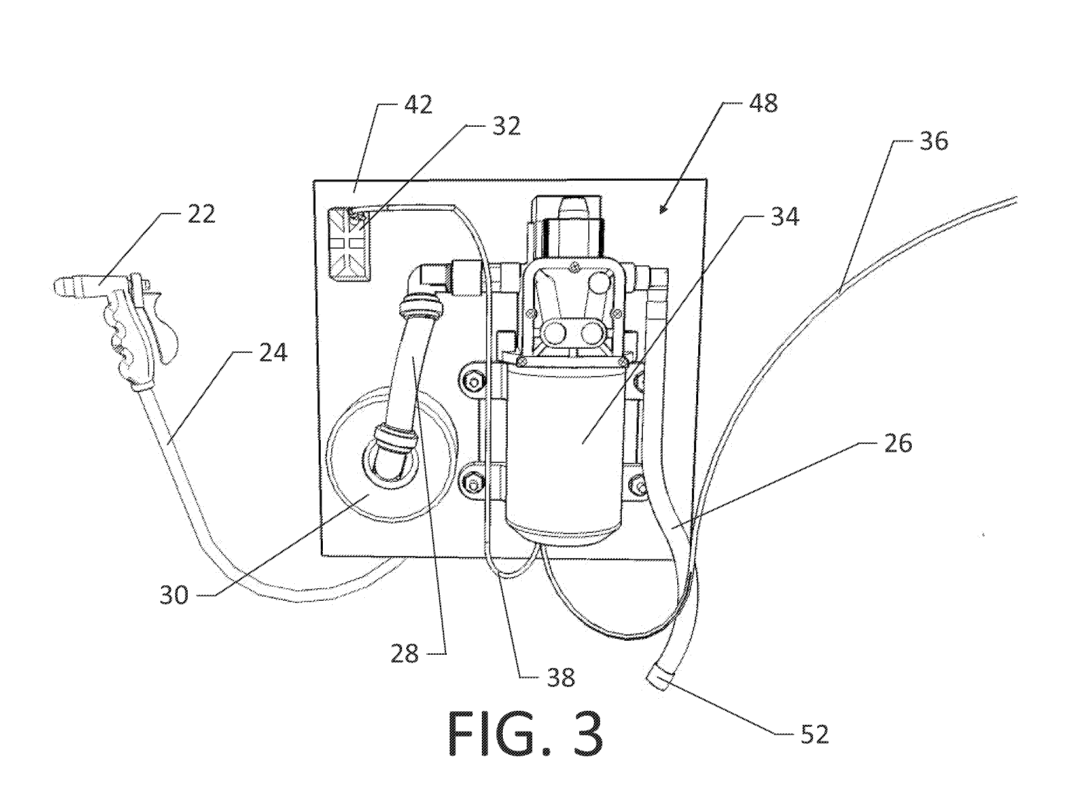

Pump assembly 48 and removable section 42 are shown in a detailed view in FIG. 3. Pump assembly 48 consists of first electric wire 36, second electric wire 38, pump 34, first tube 26, second tube 28 and switch assembly 32. Removable section 42 and pump assembly 48 can be completely detached from the main portion of container 10. Thus, the components of container 10 which are most likely in need of service (e.g. pump 34; switch assembly 32; etc) are able to be easily removed, shipped and/or serviced apart from the bulky cooler body. Additionally, if a component part of the pump assembly 48 needs replacement the user has the option of simply purchasing another pump assembly 48 with removable section 42. Spray nozzle 22 and spray nozzle tube 24 are easily removed from removable section 42 and therefore would not have to be replaced, shipped or serviced along with the other components. First electric wire 36 is incoming from a power source and attaches to pump 34. Pump 34 is attached to removable section 42 (in any known manner). Second electric wire 38 runs from pump 34 to switch assembly 32 and acts to turn pump 34 on and off. Pump 34 suctions water from first compartment 20 via filter 52 and first tube 26. Filter 52 is an optional component part of the present container 10. The pressurized water is expelled by pump 34 out of second tube 28 into spray nozzle tube 24 and ultimately out of spray nozzle 22. Pump 34 can be any high pressure pump. For example, pump 34 can be a 12 v DC high-pressure diaphragm pump (100 psi). The water expelled from spray nozzle 22 is under high-pressure and therefore can be used for numerous purposes. As examples, a fisherman may utilize the high pressured water to clean freshly caught fish or a hunter may utilize the pressurized water to clean dirty boots before getting in a vehicle after a hunt.

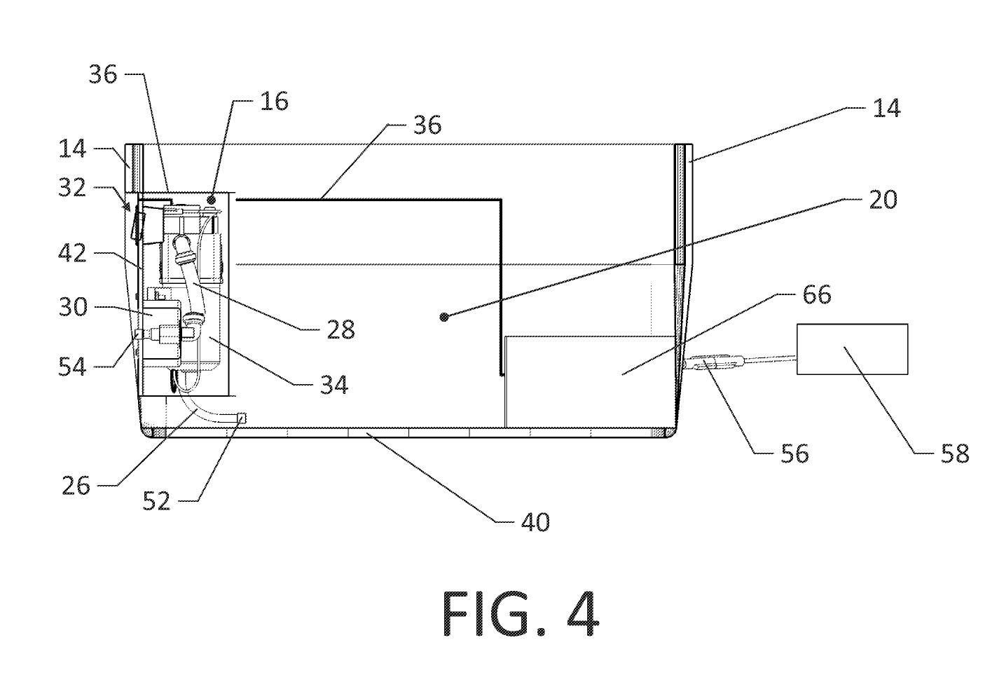

A cut-away view of container 10 is shown in FIG. 4. As illustrated second compartment 16 is a waterproof chamber apart from first compartment 20. Removable section 42 encloses second compartment 16. Switch assembly 32 runs through removable section 42 such that when the switch is in the “on” position, a signal is sent through second electric wire 38 (shown in FIG. 3) to pump 34. Likewise, connection 54 for spray nozzle and second tube 28 channel through removable section 42 to expel water through connection 54 to spray nozzle 22 (shown in FIG. 5). First electric wire 36 runs from pump 34 to third compartment 66 where an internal power source is located. An electrical connection 56 is provided to attach to an external power source 58. Power source 58 can be any known means of providing power. For example, a 12V battery could be connected via an electrical connection 56. It is in this manner that the internal power source can be recharged. In another embodiment third compartment 66 can be eliminated from the present container 10 and first electric wire 36 can travel directly through electric connection 56 to an external power source 58. It is preferable that first electric wire 36 is embedded within sidewall 14 of first compartment 20. The path of embedded portion of first electric wire 36 is shown.

FIG. 5 illustrates removable section 42 in place over second compartment (not shown in this view). Removable section 42 contains recessed portions for switch assembly 32 and nozzle connection 54. Recessed nozzle access 30 in particular prevents damage to nozzle connection 54 during transport. Spray nozzle assembly 50 can be easily removed from nozzle connection 54 and stored in container 10. Additionally, FIG. 5 shows third compartment 66 at back of container 10. Third compartment 66 holds internal power source such that entire container unit is cordless and can be operated apart from an external power source.

FIG. 6 shows first electric wire 36 extending out from the back of container 10 at third compartment 66. The internal power source, housed in third compartment 66, can be charged via external power source 58. Thus, first electric wire 36, connecting power source 58 via electrical connection 56 serves as either a direct power source for pump assembly or a charging mechanism for internal power source.

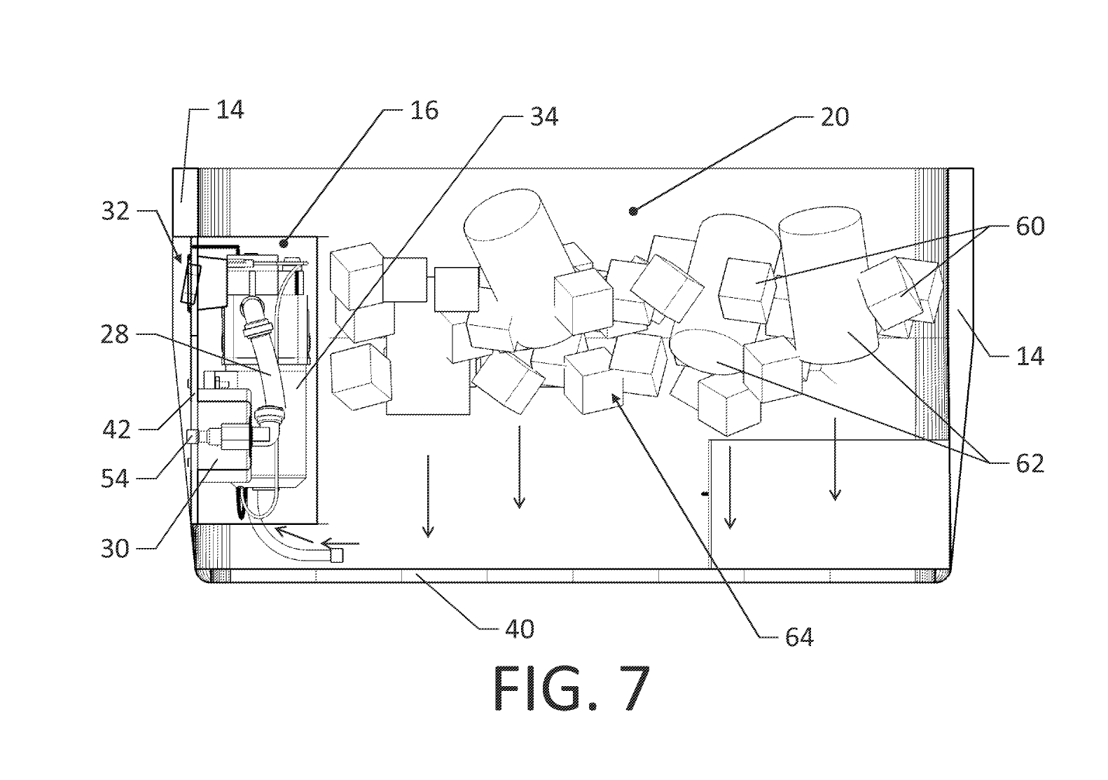

In FIG. 7 a cut away view of container 10 is shown in use. Typically, coolers are used to carry beverages and food. Thus, as an example, cans 62 are shown sitting in ice 60. As time passes ice 60 in first compartment 20 begins to melt into water 64. Water 64 accumulates at base 40 of first compartment 20. When fresh-water (or cold-water) is needed, user turns switch on switch assembly 32 to the on position and pump 34 begins to suction water 64 through filter 52 and first tube 26 into high-pressure pump 34. The path of water 64 is shown by arrows within first compartment 20. Pump 34 pressurizes water and spray nozzle assembly 50 (shown in previous figures) is used to spray water. It is in this manner that the user can utilize the accumulated fresh-water for high pressure cleaning or other activity.

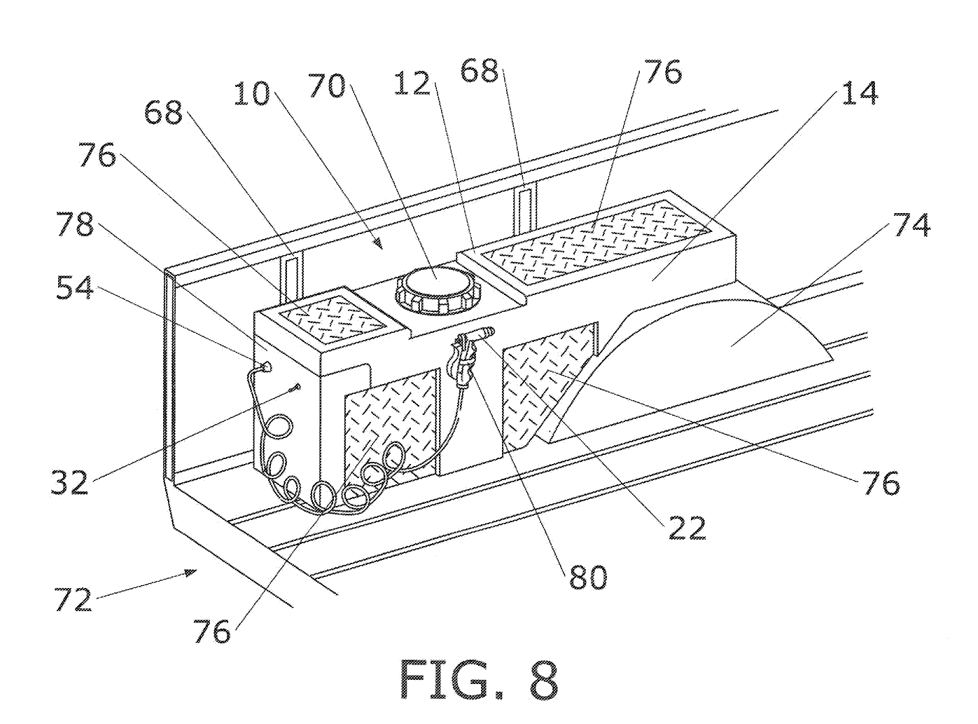

A second embodiment of container 10 is illustrated in FIG. 8. In the second embodiment, container 10 fits over the wheel well 74 in a truck bed 72 of a truck. The design of container 10 allows the user to maximize the space within the truck bed 72 by fitting into space around the wheel well 74 which is often unusable. The user still has access to the majority of the truck bed 72. Brackets 68 attach container 10 to the sidewalls of truck bed 72. However, container 10 could be attached in any manner to sidewalls of truck bed 72 or fully integrate with truck bed 72. The reader will appreciate that the present invention should not be limited to trucks but instead could be adapted for any vehicle. Additionally, container 10 can be insulated if desired. Container 10 is capable of holding and transporting a large volume of water.

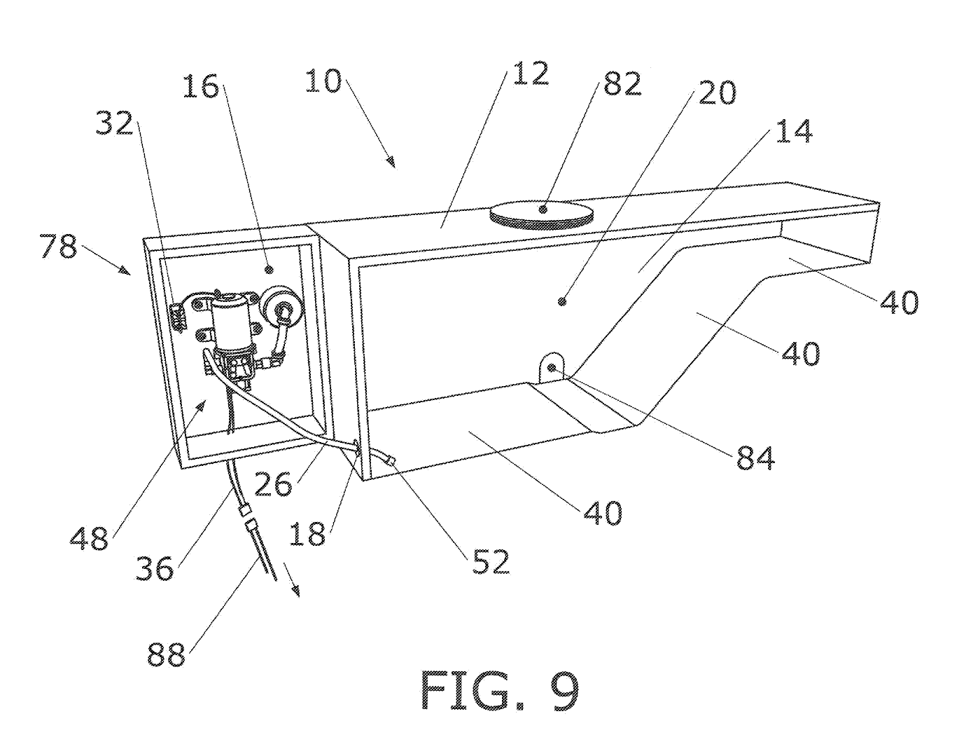

Decorative panels 76 are optional and can be added to parts of sidewall 14. Top 12 includes a lid 70 which covers an opening for filling container 10 with water. Removable section 78 attaches to sidewall 14 and houses a pump assembly (shown in FIG. 9). A switch assembly 32 and nozzle connection 54 are located on the outside wall of removable section 78. Spray nozzle 22 extends from nozzle connection 54 and connects to a holder 80 located on container 10. Holder 80 can be any known device for securing spray nozzle 22 to container 10 when not in use.

As illustrated in FIG. 9, removable section 78 can be fully removed. Removable section 78 and side wall 14 form second compartment 16 which is fluidly separate from first compartment 20. Pump assembly 48 and switch assembly 32 (described herein) are preferably coupled to said removable section 78. First tube 26 extends from pump assembly 48 through first opening 18 to first compartment 20. The end of first tube 26 includes a filter 52 to prevent debris in the water from entering first tube 26 and pump assembly 48. In the present embodiment, pump assembly 48 is preferably powered by the vehicle itself. First electric wire 36 extends from pump assembly 48 to wire harness 88 located within vehicle. An interrupted line shows the manner in which the wires connect and a small arrow indicates the wire harness 88 continues into the vehicle.

Side wall 14 (partially cut away in the present view) extends upward from base 40 forming first compartment 20. Top 12 fits over side wall 14 enclosing first compartment 20. Base 40 is shaped to accommodate wheel well (illustrated in FIG. 8). Second opening 82 in top 12 allows the user to fill container 10 with water. However, the reader will appreciate that top 12 could be optionally removable as well. Removable section 78 can be disconnected for easy access to and service of pump assembly 48. Sidewall 14 includes a drain or lower opening 84. Lower opening 84 can be formed by sidewall 14, base 40 or partially formed by both base 40 and sidewall 14.

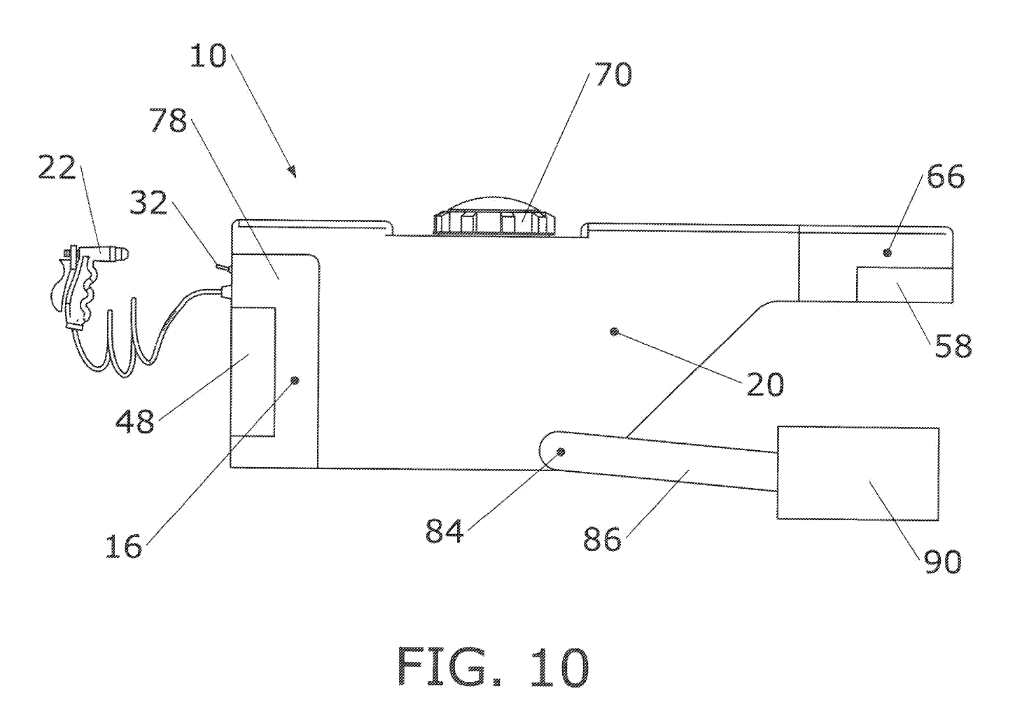

A schematic plan view is shown in FIG. 10. An optional third compartment 66 including a power source 58 is illustrated. In this embodiment, container 10 could operate without power from the vehicle. Third compartment 66 could connect to pump assembly 48 by a wire running along or inside of sidewall 14 of container 10. Additionally, lower opening 84 can act as either a drain plug (to quickly empty excess water from container 10) or as an expansion port. As an expansion port, lower opening 84 allows for the attachment of an auxiliary water tank 90 via an adapter hose 86, thereby increasing the standard water capacity of container 10.

The preceding description contains significant detail regarding the novel aspects of the present invention. It should not be construed, however, as limiting the scope of the invention but rather as providing illustrations of the preferred embodiments of the invention. As an example, second compartment 16 can be located in different areas of first compartment 20. Or power source 58 may be located within or outside of container 10. Thus, the scope of the invention should be fixed by the following claims, rather than by the examples given.

Having described my invention, I claim:

1. A container for holding water further comprising:
a. a first compartment formed by a base and a side wall extending upward from said base;
b. a top attached to said side wall;
c. a second compartment formed by a removable section and said side wall;
d. wherein said removable section is coupled to said side wall of said first compartment such that said first compartment and said second compartment are separated by said side wall;
e. wherein said second compartment includes a pump assembly;
f. wherein a first tube extends from said pump assembly in said second compartment through a first opening in said side wall to said first compartment; and
g. wherein said pump assembly is capable of expelling said water from said first compartment at a high pressure via a nozzle assembly.

2. The container of claim 1, wherein said pump assembly is coupled to said removable section.

3. The container of claim 1, wherein said sidewall and said top are insulated.

4. The container of claim 1, wherein said top opens to allow access to said first compartment.

5. The container of claim 1, further comprising a second opening in said top which connects to said first compartment.

6. The container of claim 5, further comprising a lid which covers said second opening.

7. The container of claim 1, further comprising a third compartment having an internal power source.

8. The container of claim 1, further comprising a first electric wire connecting said internal power source to said pump assembly.

9. The container of claim 8, wherein said first electric wire runs from second compartment to said third compartment through said side wall of said first compartment.

10. The container of claim 9, further comprising a second electric wire connecting said battery to an external power source.

11. The container of claim 10, wherein said external power source is a vehicle.

12. The container of claim 1, wherein said first compartment includes a lower opening capable of releasing said water from said first compartment.

13. The container of claim 12, wherein said lower opening can accept an adapter hose connected to an auxiliary water tank capable of providing access to an additional volume of water.

14. The container of claim 1, further comprising an external power source connected to said pump assembly by a first electric wire.

15. The container of claim 1, wherein said pump assembly further comprises:
a. a high pressure pump connected to said first tube;
b. a second tube connecting said high pressure pump to said nozzle assembly;
c. a second electric wire connecting said high pressure pump to a switch assembly;
d. a first electric wire connecting said high pressure pump to a power source;
e. wherein when said second electric wire sends an electrical signal to said high pressure pump, said high pressure pump is capable of utilizing said power source to collect and pressurize said water to be expelled by said nozzle assembly.

16. An container for holding water further comprising:
a. a first compartment formed by a base and at least one side wall extending upward from said base;
b. a top fitting over said first compartment;
c. a second compartment formed by said side wall and a removable section;
d. wherein said second compartment includes a pump assembly;
e. wherein a first tube connects said pump assembly to said first compartment such that said first tube is capable of accessing said water in said first compartment;
f. wherein said pump assembly includes a first wire capable of connecting to a power source to provide electricity to said pump assembly;
g. wherein said pump assembly is capable of expelling said water from said first compartment at high pressure via a nozzle assembly.

17. The container of claim 16, further comprising a third compartment attached to said side wall wherein said third compartment includes said power source.

18. The container of claim 16, wherein said pump assembly is coupled to said removable section.

19. The container of claim 16, wherein said power source is a vehicle.

20. The container of claim 16, wherein said pump assembly further comprises:
a. a high pressure pump connected to said first tube;
b. a second tube connecting said high pressure pump to said nozzle assembly;
c. a second electric wire connecting said high pressure pump to a switch assembly;
d. said first electric wire connecting said high pressure pump to said power source;
e. wherein when said second electric wire sends an electrical signal to said high pressure pump, said high pressure pump utilizes said internal power source to collect and pressurize said melted ice to be expelled by said nozzle assembly.
